(19) United States
(12) Patent Application Publication
(10) Pub. No.: US 2017/0154393 A1
(43) Pub. Date: Jun. 1, 2017

(54) RELATING TRANSPORT INCIDENT REPORTS FOR TRANSPORT INCIDENTS RESULTING FROM THE SAME TRANSPORT ACCIDENT

(71) Applicant: International Business Machines Corporation, Armonk, NY (US)

(72) Inventors: Smriti Talwar, Clonsilla (IE); Cosma Christian Toscano, Ashtown (IE); Zheng Xie, Clontarf (IE)

(21) Appl. No.: 14/955,543

(22) Filed: Dec. 1, 2015

(51) Int. Cl. G06Q 50/26; G06Q 10/10

(52) U.S. Cl. CPC G06Q 50/265; G06Q 10/10

(57) ABSTRACT

A computer-implemented method of relating transport incident reports for transport incidents resulting from the same transport accident. A transport incident report including transport incident data for a transport incident is received, where the transport incident data includes at least geographical and temporal data for the transport incident. Transport accident data associated with a set of stored transport incident reports is retrieved, which also includes at least geographical and temporal data. The transport incident data and transport accident data is used to determine that the received transport incident report relates to the same transport accident as the set of stored transport incident reports. The received transport incident report is then added to the set of stored transport incident reports.

### BACKGROUND

The present invention relates to relating transport incident reports for transport incidents resulting from the same transport accident.

Transport incident monitoring systems, for example for monitoring road traffic incidents, can be used to improve transport accident response times, for example by more quickly identifying transport accidents and alerting the appropriate accident response teams. Such transport incident monitoring systems may receive transport incident reports containing transport incident data from multiple sources, such as traffic speed monitoring devices, CCTV systems aided by intelligent video analytics, police reports, reports from members of the public, and reports from intelligent devices installed in vehicles, to give just some examples.

Often, multiple transport incident reports will relate to the same transport accident. This may be because the same transport incident is reported by more than one source, for example a police report and a CCTV system report may both identify and report that a collision has occurred. In addition, different transport incidents may result from a single transport accident, each resulting in a separate transport incident report. For example, a single traffic accident may result in traffic congestion on nearby stretches of road that are monitored by multiple different traffic speed monitoring devices. In this case, each traffic speed monitoring device will generally generate a different transport incident report indicating that traffic speed on the stretch of road that it monitors has reduced. Each transport incident report will generally contain different transport incident data, even though it relates to the same underlying transport accident.

### SUMMARY

In accordance with a first implementation, a computer-implemented method for relating transport incident reports for transport incidents resulting from the same transport accident may include, receiving a transport incident report including transport incident data for a transport incident, wherein the transport incident data may include at least geographical and temporal data for the transport incident. Stored transport accident data associated with a set of previously received transport incident reports may be received. The transport accident data may include at least geographical and temporal data. The transport incident data and transport accident data may be used to determine if the received transport incident report relates to the same transport accident as the set of previously received transport incident reports. In the case that the received transport incident report is determined to relate to the same transport accident as the set of previously received transport incident reports, the stored transport accident data may be updated using the received transport incident report.

In accordance with a second implementation, a transport incident monitoring system for relating transport incident reports for transport incidents resulting from the same transport accident may include a transport incident data store, arranged to receive a transport incident report including transport incident data for a transport incident, wherein the transport incident data may include at least geographical and temporal data for the transport incident. The transport incident data store may also be arranged to retrieve, from the transport incident data store, transport accident data associated with a set of previously received transport incident reports, wherein the transport accident data comprises at least geographical and temporal data. The transport incident data store may be arranged to use the transport incident data and transport accident data to determine if the received transport incident report relates to a same transport accident as the set of previously received transport incident reports. In the case that the received transport incident report is determined to relate to the same transport accident as the set of previously received transport incident reports, the stored transport accident data may be updated using the received transport incident report.

In accordance with a third implementation, a computer program product for relating transport incident reports for transport incidents resulting from the same transport accident, may include a computer-readable storage medium having a plurality of instructions stored thereon, which, when executed by a processor, may cause the processor to perform operations including receiving a transport incident report comprising transport incident data for a transport incident, wherein the transport incident data may include at least geographical and temporal data for the transport incident. Instructions may also be included for retrieving stored transport accident data associated with a set of previously received transport incident reports, wherein the transport accident data may include at least geographical and temporal data. Instructions may also be included for using the transport incident data and transport accident data to determine if the received transport incident report relates to the same transport accident as the set of previously received transport incident reports. Instructions may further be included for, in the case that the received transport incident report is determined to relate to the same transport accident as the set of previously received transport incident reports, updating the stored transport accident data using the received transport incident report.

It will of course be appreciated that features described in relation to one aspect of the present disclosure may be incorporated into other aspects of the present disclosure. For example, the example method may incorporate any of the features described with reference to the transport incident monitoring system and vice versa.

### BRIEF DESCRIPTION OF THE SEVERAL VIEWS OF THE DRAWINGS

Illustrative example embodiments of the present disclosure will now be described, by way of example only, with reference to the following drawings in which:

FIG. 1 is a schematic diagram showing a transport incident monitoring system in accordance with an embodiment of the disclosure;

FIG. 2 is a flowchart showing, in accordance with an embodiment of the disclosure, the operation of the transport incident monitoring system of FIG. 1 when receiving a new transport incident report;

FIG. 3 is a flowchart showing, in accordance with an embodiment of the disclosure, the operation of the transport incident monitoring system of FIG. 1 when displaying transport incident information to an operator; and

FIG. 4 is a schematic diagram showing a transport incident monitoring system in accordance with another embodiment of the disclosure.

### DETAILED DESCRIPTION

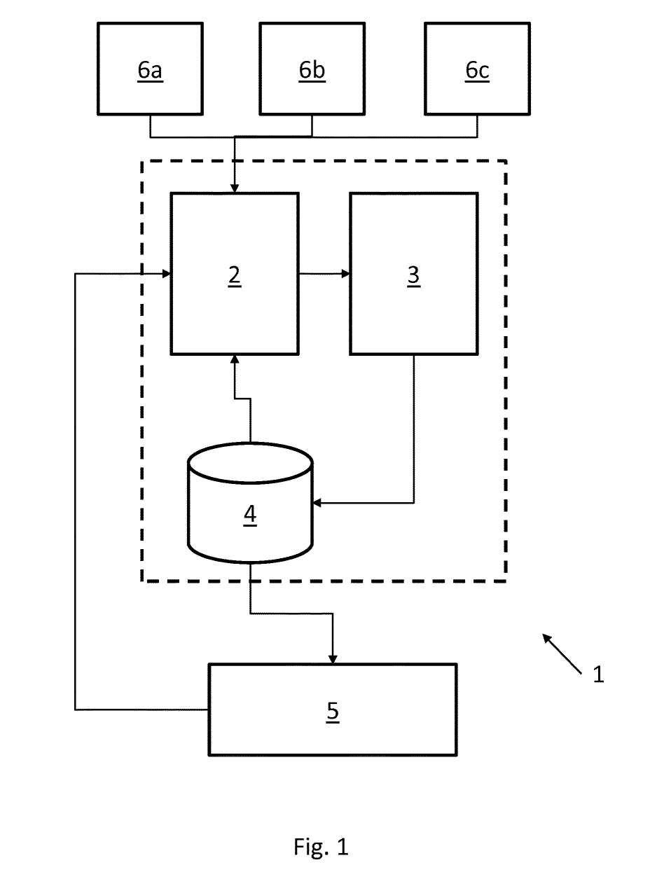

FIG. 1 shows a transport incident monitoring system in accordance with an embodiment of the present disclosure. The transport incident monitoring system may identify separate transport incident reports that relate to the same underlying transport accident, so that this task, which is often difficult and time-consuming, may not need to be performed by a human operator.

The transport incident monitoring system 1 of FIG. 1 may include a transport incident report merging module 2, a transport accident data selecting module 3, and a transport incident data store 4. The transport incident report merging module 2 of the transport incident monitoring system 1 may be in communication with multiple transport incident report sources 6a, 6b, 6c, and an operator display device 5. The operator display device 5 may also be in communication with the transport incident data store 4 of the transport incident monitoring system 1.

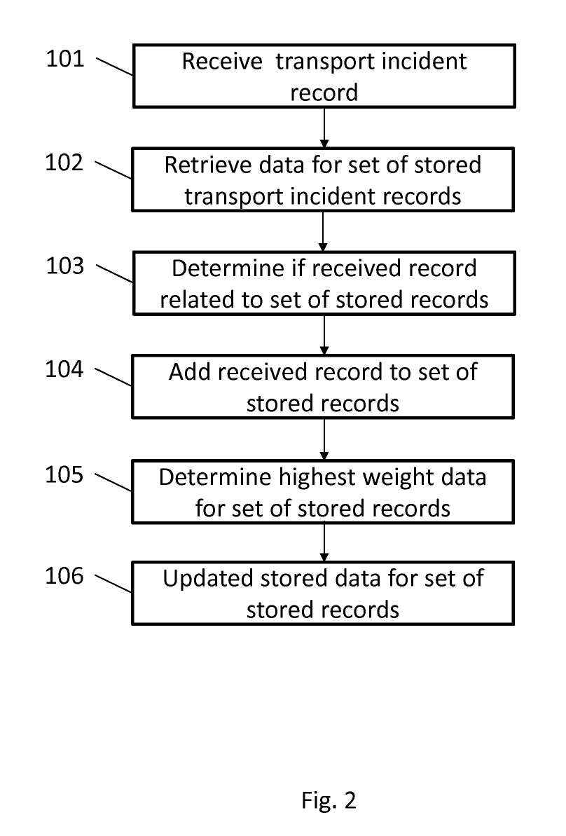

An illustrative example of the operation of the transport incident monitoring system 1 when receiving a new transport incident report is now described with reference to the flowchart of FIG. 2. The transport incident report merging module 2 of the transport incident monitoring system 1 may receive a transport incident report, containing transport incident data, for example from the transport incident report source 6a (step 101). It will be appreciated that transport incident reports may be received from different sources in different formats, and containing data corresponding to different types of information. The transport incident monitoring system 1 may include functionality that allows received transport incident reports to be transformed into a single canonical format, for example using XML or any other suitable representation. In alternative embodiments, the transport incident report merging module 2 and other components of the transport incident monitoring system 1 may be able to operate upon transport incident reports in multiple formats.

The transport incident report merging module 2 may retrieve, from the transport incident data store 4, transport accident data associated with a set of previously-received transport incident reports (step 102). As will become apparent, the present process as it is applied to received transport incident report results in sets of transport accident data associated with corresponding sets of transport incident reports being stored in the transport incident data store 4. In the present embodiment, the sets of transport incident reports may also be stored in the transport incident data store 4, but in alternative embodiments only the transport accident data is stored. In further alternative embodiments, only transport accident data derived (as described below) from the received transport incident report is stored, and the transport incident reports themselves are not stored.

Thus, in an initial state, there may be no transport accident data to retrieve, and only the later steps of operation described below will be performed. However, assuming there is transport accident data to retrieve, the transport incident report merging module 2 determines, using the retrieved transport accident data and the transport incident data of the received transport incident report, if the received transport incident report relates to the same underlying transport accident as set of stored transport incident reports (step 103). How this is done is described later below. If it is determined that the received transport incident report and set of stored transport incident reports are related, the received transport incident report may be added to the set of stored transport incident reports stored in the transport incident data store 4 (step 104).

If there are multiple sets of transport accident data stored in the transport incident data store 4, each associated with a different set of transport incident reports, the process may be repeated for those to determine if the each set of transport incident reports is related to the same transport accident as the received transport incident report. In certain embodiments, the process may only be repeated until a set of transport incident reports with which the received transport incident report is related is found. In other embodiments, the process may be continued, for all sets of transport accident data, or all those with certain properties (for example only those relating to a proximate geographical area to the received transport incident report), as this may allow separate existing sets of transport incident reports to be identified as relating to the same underlying transport accident, on the basis of the additional information provided by the received transport incident report.

Finally, in the case described above in which that there was no transport accident data to retrieve from the transport incident data store 4, or in the case that no set of stored transport incident reports was determined to be related to the received transport incident report, the received transport incident report may be added to the transport incident data store 4 as a set comprising the received transport incident report only.

The transport incident report merging module 2 may then pass the set of stored transport incident reports (including the newly added received transport incident report) to the transport accident data selecting module 3. Each transport incident report may contain transport incident data. As described in more detail below, the transport incident data may include multiple items of relevant data, for example a geographical location of the incident, a time of the incident, type of incident and so on.

The transport accident data selecting module 3 may assign weights to certain of the items of relevant data (step 105). Weights may be determined for all of the stored transport incident reports. In an alternative embodiment, weights may be determined only for the received transport incident report that was added to the stored set of transport incident reports, and the weights for the existing stored transport incident reports may be retrieved from the transport incident data store 4, having been stored there after being determined when those transport incident reports were received.

The weights may be indicative of the accuracy of the items of data. The weights may be determined using the details of the source of the transport incident report, for example its type and the transport system (e.g. road network) on which it operates, and any other appropriate data from the transport incident report. For example, where the source is a traffic speed monitoring device, the estimated traffic speed may be likely to be very accurate so given a high weight, while any indication of the cause of the transport incident may be given a low weight. In contrast, where the source is a CCTV system aided by intelligent video analytics, any indication of the cause of the transport incident may be likely to be accurate so given a high weight, while any estimated of traffic speed may be given a low weight. Similarly, an indication of the cause of the transport incident where the source is a police report may be given a very high weight, while an indication of the cause of the transport incident where the source is a report from a member of the public may be given a lower weight.

The transport accident data selecting module 3 may then select the items of data with the highest weights, as providing the highest accuracy data for the underlying transport accident. These are used to update the transport accident data stored in the transport incident data store 4 (step 106).

In the case that the received transport incident report was used to create a new set containing only itself, the transport accident data may be created using only the items of data for the received transport incident report. In certain embodiments, in this situation the transport accident data may be the received transport incident report itself. The received transport incident report may then be updated using subsequently received transport incident reports, so that the transport incident data store 4 stores a set of transport incident reports corresponding to a set of transport accidents (i.e. one transport incident report for each transport accident), where each stored transport incident reports may be a result of one or more received transport incident reports being “fused” together by the transport accident data selecting module 3.

It will be appreciated that the transport accident data selecting module 3 may modify items of data for transport incident reports in appropriate ways when updating/creating the transport accident data. To give just one example, a traffic speed monitoring device may report a time for the transport incident, the incident being the traffic speed reducing. However, the greater the distance between the traffic speed monitoring device and the underlying traffic accident, the greater the delay there will be between the traffic accident occurring and the resulting traffic speed reduction. To allow for this, the transport accident data selecting module 3 can use the various items of data it has received to determine that delay, and modify the incident time provided by the traffic speed monitoring device appropriately.

The operation of the transport incident report merging module 2 is now described, when determining, using the retrieved transport accident data and the transport incident data of the received transport incident report, if the received transport incident report relates to the same underlying transport accident as set of stored transport incident reports.

As disused above, a transport incident report contains transport incident data, which may include various items of data such as Location, Creation Time, Update Time, Severity, Priority, Status, Type, Source, Description, Queue Length, Number of Vehicles Involved, and the like. As will be apparent, the particular items of data included may depend on the nature of the source of the transport incident report.

The transport incident report merging module 2 may compare the transport incident data with the transport accident data from the transport incident data store 4. As discussed in more detail below, the transport accident data may be a collection of items of data obtained from the set of stored transport incident reports associated with the retrieved transport accident data. The items of data may be taken directly from the stored transport incident reports, or may be modified, again as described in more detail below.

The transport incident report merging module 2 may determine various relevance scores between the received transport incident report and the retrieved transport accident data.

An example relevance score is a spatial relevance score, which indicates how closely the transport incident represented by the received transport incident report is located to the transport accident as represented by the retrieved transport accident data, i.e. the underlying transport accident that it has previously determined caused the transport incident reports in the stored set of transport incident reports. For example, the closer the proximity, the higher spatial relevance score can be given. For road traffic, for example, this may be based on the fact that when a traffic accident occurs, drivers on adjacent roads tend to slow down, either because of congestion that is caused or simply to view the accident. In a more complicated example, traffic speed monitoring devices each monitor linked segments of a road. When an accident occurs in one segment, congestion will be caused, and over time a queue of vehicles of increasing length may be formed. As a result, traffic speed monitoring devices along the path of the queue may provide successive transport incident reports. By traversing the traffic links from the location of the first transport incident report, it can be determined that the successive transport incident reports are likely caused by the same accident, so given a high spatial relevance score (even though there may be a greater spatial distance between them). The spatial relevance score may also depend upon other surrounding incidents, such as a building on fire, by using the distance of this type of incidents from the road.

In a similar fashion, a temporal relevance score can be determined. The closer in time transport incidents are determined to begin, the higher temporal relevance score they can be given. In addition, successive transport incidents may be determined to be likely caused by the same accident, taken into account for example the time a traffic queue takes to form as well as its length.

Another example relevance score is a textual relevance score, which considers text data items, such as a type or description of the transport incident. For example, it may have been determined that the underlying transport accident was an oil spill, and this reported in some appropriate way in the transport accident data. If the description of the transport incident provided by the received transport incident report is “car on fire”, this can be determined to be sufficiently similar to an oil spill that a high textual relevance score may be given. The transport accident data may include the text descriptions used for all the set of stored transport incident reports, for example, to provide a large set of text items for comparison.

A particular advantage of the textual relevance score may be that it helps distinguish transport incident reports that are close in location and/or time. For example, a lightning strike may cause a set of traffic lights to stop working, and soon after this results in a collision. A traffic light system monitor may generate a transport incident report relating to the lights malfunction, while a CCTV system generates a transport incident report relating to the collision. While the incidents underlying the two transport incident reports are close in location and time, separate actions may be required to correct them, and so they should not be determined to relate to the same underlying transport accident.

When all the various relevance scores have been determined, they may be used to determine whether the received transport incident report relates to the same underlying transport accident as the set of stored transport incident reports.

It will be appreciated that historical data, such as the time traffic queues have taken to when previous accidents have occurred in the same location, or words/phrases used in different text descriptions that have been found to be related on past occasions, can be used to make the various relevance scores more accurate. It will also be appreciated that the relevance scores can be weighted as required by the particular transport system (e.g. traffic network), and the weightings modified over time if required, in order to achieve the most accurate determinations.

It will also be appreciated that various other of many well-known statistical methods, such as statistical models to give just one example, could be used to determine that the received transport incident report relates to the same underlying transport accident as the set of stored transport incident reports.

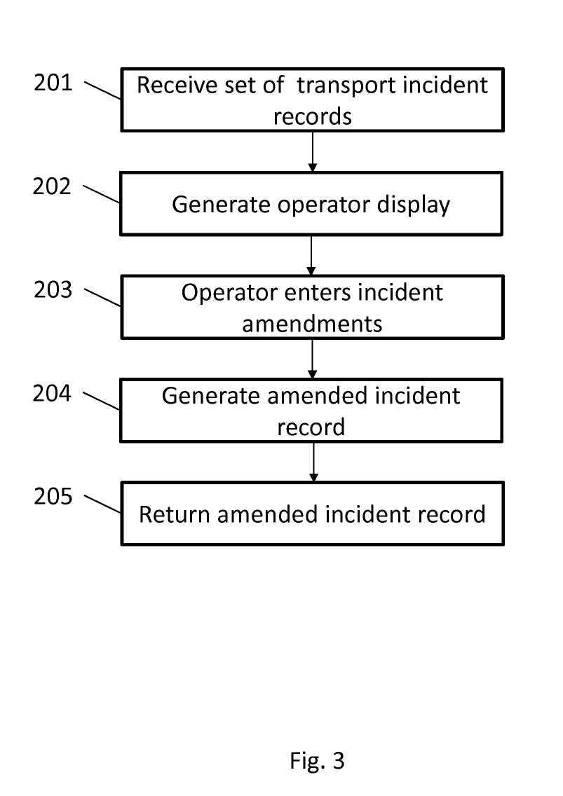

The transport incident monitoring system 1 when displaying transport incident information to an operator is now described with reference to the flowchart of FIG. 3. The operator display device 5 may receive a set of transport incident reports from the transport incident data store 4 (step 201), i.e. a set of transport incident reports that have been determined by the transport incident monitoring system 1 to relate to the same underlying traffic accident. The operator display device 5 may also receive the associated transport accident data.

The operator display device 5 may use the set of transport incident reports, and associated transport accident data if appropriate, to generate a display for the operator (step 202), for example a map of the transport system (e.g. road network) showing the transport incident reports in appropriate locations, along with relevant items of data. The operator can then use this information to alert the appropriate accident response team, or any other required action.

The operator may identify that there are errors in the displayed items of data. For example, the operator may identify that the transport incident monitoring system 1 has determined that a set of transport incident reports relate to a single underlying traffic accident, when in fact there is more than one, for example two different collisions in close proximity. Similarly, the operator may identify that the transport incident monitoring system 1 has determined that there are two separate underlying traffic accidents, when in fact there is only one. Other possibilities include (but are not limited to) that the operator identifies that the transport incident monitoring system 1 has not picked the most accurate of available items of data, or the operator may simply provide additional/more refined information, for example additional or more specific information about the cause of the underlying traffic accident.

The operator provides any required data amendments using an input device of the operator display device 5, such as a keyboard (step 203). The operator display device 5 may use these to generate an amended transport incident report (step 204), which may be passed to the transport incident report merging module 2 of the transport incident monitoring system 1, which may be processed as described above. This allows the operator to provide updates/corrections to the transport incident monitoring system 1.

In the present embodiment, the transport accident data selecting module 3 may be arranged to assign all amended items of data in the amended transport incident report the highest weights. This may ensure that the operator's amendments are used in preference to items of data in transport incident reports from any other sources. In other embodiments, other weighting schemes may be used for the items of data of the amended transport incident report.

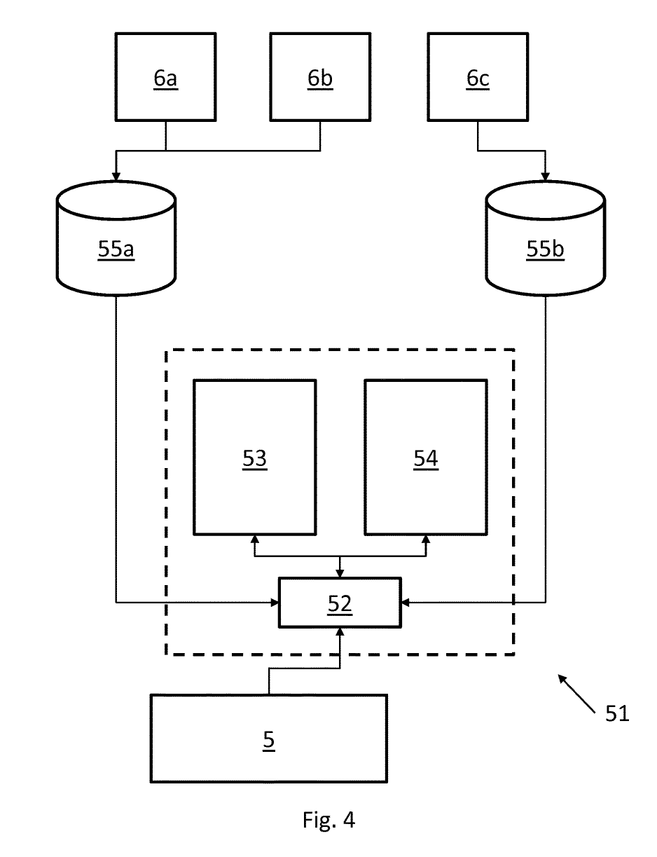

FIG. 4 shows a transport incident monitoring system in accordance with another embodiment of the invention. The transport incident monitoring system 51 again may include a transport incident report merging module 53 and a transport accident data selecting module 54, but which in the present embodiment are in communication with a transport incident system controller 52. The transport incident system controller 52 may be in communication with an operator display device 5.

As in the previous embodiment, there are multiple transport incident report sources 6a, 6b, 6c. However, in the present embodiment the transport incident report sources 6a and 6b send transport incident reports to a transport incident report store 55a, and the transport incident report source 6c sends transport incident reports to a transport incident report store 55b. The transport incident system controller 52 is in communication with both the transport incident report store 55a and the transport incident report store 55b. It will be appreciated that various other arrangements would be possible.

In operation, as in the previous embodiment the transport incident report sources 6a, 6b, 6c may generate transport incident reports, which are now sent to the transport incident report store 55a or 55b. The transport incident system controller 52 may then receive the transport incident reports from the transport incident report stores 55a and 55b, and passes them to the transport incident report merging module 53 to determine if they relate to the same transport accident as previously received transport incident reports as described above, and to the transport accident data selecting module 54 to determine the transport incident data from them to select, again as described above. However, rather than storing selected transport accident data and/or the received transport incident reports in a separate store, the transport incident system controller 52 may instead obtain and/or derive the required reports and/or data as required, from the transport incident reports stored in the transport incident report stores 55a and 55b.

While the present disclosure has been described and illustrated with reference to particular embodiments, it will be appreciated by those of ordinary skill in the art that the invention lends itself to many different variations not specifically illustrated herein.

While examples have been given in which an embodiment of the disclosure is used for road traffic, it will be appreciated that the embodiments of the disclosure are equally applicable to aviation, shipping, overground and underground rail system, and any other transport systems, and indeed to other systems that have automatic diagnosis from different sources.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions reported thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
receiving, by a computing device, a transport incident report comprising transport incident data for a transport incident, wherein the transport incident data comprises at least geographical and temporal data for the transport incident;
retrieving, by the computing device, stored transport accident data associated with a set of previously received transport incident reports, wherein the transport accident data comprises at least geographical and temporal data;
using, by the computing device, the transport incident data and transport accident data to determine if the received transport incident report relates to a same transport accident as the set of previously received transport incident reports; and
in the case that the received transport incident report is determined to relate to the same transport accident as the set of previously received transport incident reports, updating, by the computing device, the stored transport accident data using the received transport incident report, wherein the updated transport accident data comprises items of data selected from transport incident data of the received transport incident report and transport incident data of the set of previously received transport incident reports, and wherein the items of data are assigned weights indicative of the accuracy of their source, and the selected items of data are the items of data with weights indicative of the highest accuracy of their source.

2. (canceled)

3. The computer-implemented method as claimed in claim 1, further comprising storing the received transport incident report.

4. (canceled)

5. The computer-implemented method as claimed in claim 1, further comprising sending the set of stored transport incident reports to an operator display device.

6. The computer-implemented method as claimed in claim 5, further comprising:
receiving transport incident data amendments from an operator of the operator display device; and
generating an amended transport incident report comprising the received transport incident data amendments.

7. The computer-implemented method as claimed in claim 6, wherein the received transport incident data amendments of the generated amended transport incident report are assigned weights indicative of the highest level of accuracy.

8. The computer-implemented method as claimed in claim 1, wherein the transport incident data and transport accident data include respective type data indicative of the type of transport accident, and wherein the received transport incident report is determined to relate to the same transport accident as the set of stored transport incident reports only if their respective type data are not indicative of different types of transport accident.

9. The computer-implemented method as claimed in claim 1, wherein the transport incident and transport accident are a road transport incident and a road traffic accident respectively.

10. A transport incident monitoring system that includes a processor system and memory storing code which when executed by the processor system causes the transport incident monitoring system to:
receive a transport incident report comprising transport incident data for a transport incident, wherein the transport incident data comprises at least geographical and temporal data for the transport incident;
retrieve, from a transport incident data store, transport accident data associated with a set of previously received transport incident reports, wherein the transport accident data comprises at least geographical and temporal data;
use the transport incident data and transport accident data to determine if the received transport incident report relates to a same transport accident as the set of previously received transport incident reports; and
in the case that the received transport incident report is determined to relate to the same transport accident as the set of previously received transport incident reports, update the stored transport accident data using the received transport incident report, wherein the updated transport accident data comprises items of data selected from transport incident data of the received transport incident report and transport incident data of the set of previously received transport incident reports, and wherein the items of data are assigned weights indicative of the accuracy of their source, and the selected items of data are the items of data with weights indicative of the highest accuracy of their source.

11. (canceled)

12. The transport incident monitoring system as claimed in claim 10, further arranged to store the received transport incident report in the transport incident data store.

13. (canceled)

14. The transport incident monitoring system as claimed in claim 10, further arranged to send the set of stored transport incident reports to an operator display device.

15. The transport incident monitoring system as claimed in claim 14, further arranged to:
receive transport incident data amendments from the operator display device; and
generate an amended transport incident report comprising the received transport incident data amendments.

16. The transport incident monitoring system as claimed in claim 15, wherein the received transport incident data amendments of the generated amended transport incident report are assigned weights indicative of the highest level of accuracy.

17. The transport incident monitoring system as claimed in claim 10, wherein the transport incident data and transport accident data include respective type data indicative of the type of transport accident, and wherein the received transport incident report is determined to relate to the same transport accident as the set of stored transport incident reports only if their respective type data are not indicative of different types of transport accident.

18. The transport incident monitoring system as claimed in claim 10, wherein the transport incident and transport accident are a road transport incident and a road traffic accident respectively.

19. A computer program product comprising a computer-readable storage medium having a plurality of instructions stored thereon, which, when executed by a processor, cause the processor to perform operations comprising:
retrieving stored transport accident data associated with a set of previously received transport incident reports, wherein the transport accident data comprises at least geographical and temporal data;
using the transport incident data and transport accident data to determine if the received transport incident report relates to a same transport accident as the set of previously received transport incident reports; and
in the case that the received transport incident report is determined to relate to the same transport accident as the set of previously received transport incident reports, updating the stored transport accident data using the received transport incident report, wherein the updated transport accident data comprises items of data selected from transport incident data of the received transport incident report and transport incident data of the set of previously received transport incident reports, and wherein the items of data are assigned weights indicative of the accuracy of their source, and the selected items of data are the items of data with weights indicative of the highest accuracy of their source.

20. (canceled)
